(19) United States
(12) Patent Application Publication
(10) Pub. No.: US 2025/0003866 A1
(43) Pub. Date: Jan. 2, 2025

(54) METHOD FOR MEASURING OPTICAL PROPERTIES AND GEOMETRIC PROPERTIES OF THIN FILM MATERIAL

(71) Applicant: HUAZHONG UNIVERSITY OF SCIENCE AND TECHNOLOGY, Hubei (CN)

(72) Inventors: Xiuguo Chen, Hubei (CN); Shuo Liu, Hubei (CN); Shiyuan Liu, Hubei (CN)

(73) Assignee: HUAZHONG UNIVERSITY OF SCIENCE AND TECHNOLOGY, Hubei (CN)

(21) Appl. No.: 18/461,487

(22) Filed: Sep. 5, 2023

(30) Foreign Application Priority Data
Jun. 28, 2023 (CN) 202310784054.0

(51) Int. Cl. G01N 21/21; G01B 11/24; G06N 3/0464; G06N 3/084

(52) U.S. Cl. CPC G01N 21/211; G01B 11/24; G06N 3/0464; G06N 3/084

(57) ABSTRACT

Disclosed is a method for measuring optical properties and geometric properties of a thin film material, which belongs to the field of ellipsometry. The method realizes the automation of the ellipsometry data analysis with accurate results and includes using a spline model and a forward optical property model to generate a training set; training a neural network model; sequentially inputting preliminary results of geometric parameters and spline parameters of a material obtained by inputting the measured optical characterization quantity into the neural network into the spline model and the forward optical property model to obtain a theoretical optical characterization quantity. After optimizing the neural network model by using the deviation between the theory and the measured optical characterization quantity, the predicted value of the output is the final geometric and optical property parameters of the material.

### CROSS-REFERENCE TO RELATED APPLICATION

This application claims the priority benefit of China application serial no. 202310784054.0, filed on Jun. 28, 2023. The entirety of the above-mentioned patent application is hereby incorporated by reference herein and made a part of this specification.

### BACKGROUND

### Technical Field

The disclosure belongs to the field of ellipsometry, and more specifically relates to a method for measuring optical properties and geometric properties of a thin film material.

### Description of Related Art

Nano-thin film is a common structure in the manufacture of semiconductor devices, and the thickness and optical properties of the material thereof have significant influences on the performance of the device. The basic principle of ellipsometry technology is to measure and analyze the light intensity information scattered after the interaction between the incident light and the sample, obtain the change of the polarization state of the beam, and then extract the parameters to be obtained in the sample. This technology may simultaneously characterize the geometric structure parameters such as the thickness of the thin film sample and the optical properties of the material, and has the advantages of low cost and non-destructiveness, so the technology is widely used in measurement of semiconductor field.

In addition to measuring instruments, the successful implementation of ellipsometry relies on parameter extraction algorithms. For the analysis of new thin film materials, the commonly used algorithm is the nonlinear regression method. The main process is as follows: the first is to establish a forward optical property model; the second is to provide initial values such as thickness and optical properties of the sample to be tested and iteratively adjust the parameters under test, so that the theoretical characterization quantity calculated by the forward optical property model matches the measured characterization quantity. This process is also known as the inverse problem solving for optical scattering. Poor selection of the initial value will cause the optimization to fall into a local optimal solution. Therefore, it is necessary for practitioners to have sufficient prior knowledge of the sample, such as the nominal thickness of the sample, the selection and establishment of the material optical property model, etc.

In recent years, with the development of machine learning technology, the technology has made direct extraction of the parameters to be measured from optical characterization quantity possible. To address the issue, the following methods are usually adopted in the related art: by establishing a cascaded neural network and adding a fitting process containing a forward network to optimize the extraction results, however the accuracy of the forward network is limited by the data in the training set; or by using U-NET Network to realize direct extraction of optical constants; or through extraction of optical constants using thin film neural networks. However, none of the above methods are able to guarantee that the real and imaginary parts of the predicted optical constants meet the physical constraints, resulting in deviations in the predicted optical constants. In addition, the extraction method based on machine learning has the disadvantage of poor generalization, that is, a trained machine learning model may only be applied to a specific sample and measurement configuration.

### SUMMARY

To solve the above defects or make improvement to the related art, the present disclosure provides a method for measuring the optical properties and geometric properties of thin film materials. After the neural network is trained, the optical property spline model and forward optical property model are further utilized in the application phase to further optimize the neural network. Therefore, the accuracy of the prediction results of the neural network is not affected by the training set. Moreover, since the spline model is used to describe the dielectric function, the real and imaginary parts of the predicted optical properties of the material meet the physical constraints, thus improving the accuracy of measurement results. Additionally, in the application phase, the preset measurement conditions corresponding to the forward optical property model may also be adjusted according to the actual measurement situation, and then the neural network is optimized according to the optical property spline model and the forward optical property model. Therefore, the model may be generalized for the characterization quantity of different measurement configurations and samples.

In order to achieve the above purpose, according to the first aspect of the present disclosure, a method for measuring optical properties and geometric properties of a thin film material is provided, including:

### Training Phase:

S1: The spline parameter bⱼ is determined according to the dielectric function εⱼ(E)=ε_{j,1}(E)+iε_{j,2}(E) and optical property spline model of m different thin film materials respectively; the geometric parameters of the thin film sample are randomly selected within the preset range to obtain multiple geometric parameter sets x₁, x₂, . . . , xₙ, each εⱼ and the set xₖ are input to the forward optical property model corresponding to the measurement conditions in the training phase to obtain the theoretical optical characterization quantity y_{j,k}^{t} to construct the training set; j∈[1, m], k∈[1, n].

S2: y_{j,k}^{t} is taken as input, and corresponding bⱼ and xₖ serve as output, the training set is adopted to train the neural network.

### Application Phase:

S1′: The measured optical characterization quantity y^{mea} of the thin film material to be tested under the measurement conditions in the application phase is obtained and input into the trained neural network to obtain b^{pre} and x^{pre}.

S2′: b^{pre} is input into the optical property spline model to obtain εₚᵣₑ.

S3′: ε^{pre} and x^{pre} are input into the forward optical property model corresponding to the measurement conditions in the application phase to obtain the corresponding theoretical optical characterization quantity y^{t}. The trained neural network is optimized with the goal of minimizing the deviation between y^{mea} and y^{t}. The measurement conditions in the application phase are the same as or different from the measurement conditions in the training phase.

S4′: y^{mea} is input into the optimized neural network to obtain b′^{pre} and x′^{pre}, and b′^{pre} is input into the optical property spline model to obtain ε′^{t}.

According to the second aspect of the present disclosure, there is provided a system for determining optical properties and geometric properties of a thin film material, including: a computer-readable storage medium and a processor.

The computer-readable storage medium is configured to store executable instructions.

The processor is configured to read executable instructions stored in the computer-readable storage medium, and execute the method as described in the first aspect.

According to a third aspect of the present disclosure, a computer-readable storage medium is provided, the computer-readable storage medium stores computer instructions, and the computer instructions are provided to make a processor to execute the method as described in the first aspect.

Generally speaking, compared with the related art, the above technical solutions conceived by the present disclosure may achieve the following advantageous effects:

(1) Compared with the conventional extraction method, the method provided by the present disclosure may make it possible to reduce dependence on the engineering experience of technicians and realize the intelligence of the measurement process.

(2) During the process of optimizing the neural network model by using the spline model and the forward optical property model, the measurement configuration may be changed, so the model may be generalized to characterize samples under different measurement configurations.

(3) In the method, part of the output of the neural network is ignored, and changing the corresponding settings of the spline model and the forward optical property model will not affect the entire extraction process, so the model is possible to be flexibly applied to the test of samples with various geometric structures.

(4) Compared with existing characterization methods, the accuracy of neural network prediction results in the method provided by the present disclosure is not affected by insufficient data sets.

(5) Compared with the existing characterization methods, the introduction of the spline model may ensure that the extracted optical properties of the material have physical meaning.

### BRIEF DESCRIPTION OF THE DRAWINGS

FIG. 1 is a flow chart of optical properties and geometrical properties measuring method of a thin film material provided by an embodiment of the present disclosure.

FIG. 2 is a geometric feature figure of a sample of a constructing training set and a test sample 1 in an embodiment of the present disclosure.

FIG. 3 is a geometric feature figure of a test sample 2 in an embodiment of the present disclosure.

FIG. 4 is a geometric feature figure of a test sample 3 in an embodiment of the present disclosure.

FIG. 5 is a comparison chart of the characterization results of the test sample 1 in an embodiment of the present disclosure.

FIG. 6 is a comparison chart of the characterization results of the test sample 2 in an embodiment of the present disclosure.

FIG. 7 is a comparison chart of the characterization results of the test sample 3 in an embodiment of the present disclosure.

### DESCRIPTION OF THE EMBODIMENTS

In order to make the object, technical solution and advantages of the present disclosure clearer, the present disclosure will be further described in detail below in conjunction with the accompanying drawings and embodiments. It should be understood that the specific embodiments described here are only used to explain the present disclosure, not to limit the present disclosure. In addition, the technical features involved in the various embodiments of the present disclosure described below can be combined with each other as long as they do not conflict with each other.

An embodiment of the present disclosure provides a method for measuring optical properties and geometric properties of a thin film material, including:

### Training Phase:

S1: The spline parameter bⱼ is determined according to the dielectric function εⱼ(E)=E_{j,1}(E)+iε_{j,2}(E) and optical property spline model of m different thin film materials respectively; the specific geometric structure of the thin film sample is determined: the geometric parameters of the thin film sample are randomly selected within a preset range to obtain multiple geometric parameter sets x₁, x₂, . . . , xₙ, each εⱼ and the set xₖ are input to the forward optical property model corresponding to the measurement conditions in the training phase to obtain the theoretical optical characterization quantity y_{j,k}^{t} to construct the training set; the training set is composed of y_{j,k}^{t} and bⱼ and xₖ corresponding to y_{j,k}^{t}.

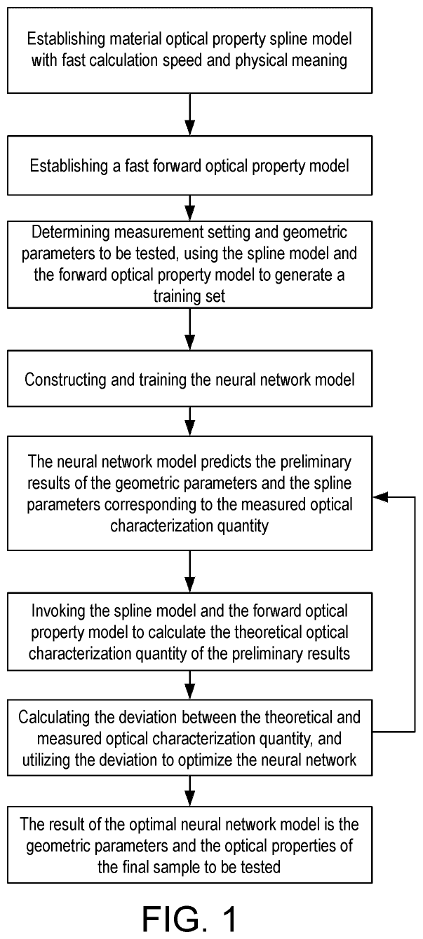

Specifically, as shown in FIG. 1, firstly, a material optical property spline model with fast calculation speed and physical meaning is established, and the model may calculate the optical property curves of given nodes and coefficients.

The optical property spline model may reconstruct the curve of the real part and the imaginary part of the material dielectric function from a set of coefficients under a certain node configuration, and the calculation formula of the real part may be deduced from the calculation formula of the imaginary part by the Kramers-Kronig consistency relation (and vice versa), and the B-spline model is often used. The node configuration includes setting the position and number of nodes.

Preferably, an optical property spline model is established based on the B-spline model.

Alternatively, based on the B-spline model and the pole oscillator model, the optical property spline model is established.

Further, in this embodiment, an optical property spline model based on cubic B-spline and pole oscillator model is established, the spline parameters include B-spline coefficients and oscillator parameters denoted as b=[b₁, b₂, . . . , b_{M}]^{T}, where M is the total number of the spline parameters. According to the given spline parameters, the real part ε₁ and the imaginary part ε₂ of the dielectric function of the material may be calculated, which are respectively a vector of 1×N, where N is the number of preset measurement wavelengths.

The optical property spline model established based on cubic B-spline and pole oscillator model is as follows:

$${ε}_{2} ( E ) = {\sum }_{i = 1}^{M - 2} {b}_{i} {B}_{i}^{3} ( E )$$

$${ε}_{1} ( E ) = {b}_{M - 1} - \frac{{b}_{M}}{{E}^{2}} + {\sum }_{i = 1}^{M - 2} {b}_{i} {ϕ}_{i}^{3} ( E )$$

In the formula, E is a photon energy of a measured wavelength, Bᵢ³(E) and ϕᵢ³(E) are the cubic basis functions utilized to calculate the imaginary part and real part of the dielectric function respectively, and the solution of the basis functions may be obtained by the following formula:

$${B}_{i}^{0} ( E ) = \{ \begin{matrix}1 , & {t}_{i} \leq E < {t}_{i + 1} \\ 0 , & other\end{matrix}$$

$${B}_{i}^{k} ( E ) = ( \frac{E - {t}_{i}}{{t}_{i + k} - {t}_{i}} ) {B}_{i - 1}^{k} ( E ) + ( \frac{{t}_{i + k + 1} - E}{{t}_{i + k + 1} - {t}_{i + 1}} ) {B}_{i + 1}^{k - 1} ( E )$$

$${ϕ}_{i}^{k} ( E ) = \frac{2}{π} P \int \frac{{E}^{′} {B}_{i}^{k} ( {E}^{′} )}{{E}^{′2} - {E}^{2}} {dE}^{′}$$

In the equation, tᵢ is a node of the spline, k∈[1,3].

It is worth noting that the basis functions of the real part in the optical property spline model are derived from the basis functions of the imaginary part through the Kramers-Kronig consistency condition, which allows ε₁ and ε₂ to maintain Kramers-Kronig consistency. In addition, the matrix operation may be used to replace the conventional recursive algorithm during programming, and the values of different basis functions in the whole band may be calculated simultaneously, so it is possible to quickly calculate the dielectric function curve.

According to the dielectric function (E)=ε₁(E)+iε₂(E) and optical property spline model of thin film samples of different materials, the least squares fitting is carried out to obtain the spline parameters b=(b₁, . . . , b_{M}), where M is the number of spline parameters.

The above thin film samples of different materials may include at least one of semiconductors (such as silicon, germanium, etc.), oxides (such as titanium oxide, zinc oxide, etc.), metals (such as gold, copper, etc.), and the like.

Secondly, a fast forward optical property model is established, which may calculate the optical characterization quantity corresponding to the geometric properties and material optical properties of the given sample under the preset measurement configuration.

Then, according to the spline model, the spline parameters of the optical property curves of various materials are obtained, and the established forward optical property model and the preset measurement configuration (that is, the preset measurement conditions: measurement conditions of application phase) are utilized to randomly select the geometric parameters of the sample within the specific parameter range, and the corresponding theoretical optical characterization quantity are calculated to obtain a training data set including optical characterization quantity, spline parameters and geometric parameters.

Preferably, the forward optical property model may be established based on the thin film transmission matrix algorithm, and the recursive algorithm of the cycle may be replaced by matrix operation in the programming method, and the theoretical optical characterization quantity under different measurement configurations (that is, preset measurement conditions, such as: incident angle, thin film material, etc.) of the whole band may be calculated simultaneously, so as to achieve the purpose of fast calculation.

Furthermore, the forward optical property model may also be established based on rigorous coupled wave analysis, boundary element method or finite-difference time-domain method; and the model may be programmed through the concept of matrix operation, which has extremely fast calculation speed.

Preferably, the geometric parameter is at least one of a thickness, a roughness and a non-uniformity.

Preferably, the optical characterization quantity is at least one of a reflectance, a transmittance, ellipsometric parameters, and a Mueller matrix.

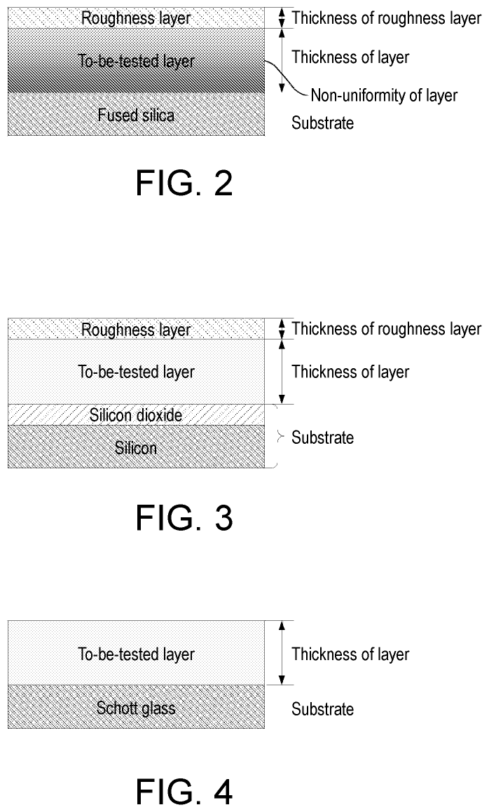

In this embodiment, the optical characterization quantity is selected as the (N, C, S) spectrum under the incident angle of 65° and the transmittance spectrum under the incident angle of 0°, denoted as y=[y₁, y₂, . . . >y_{n×4}]^{T}, where n is the number of measurement wavelengths. In the measurement conditions, the measurement wavelength is set to 1.26 to 4.13 eV, the wavelength interval is 0.01 eV, and the substrate is 0.6 mm fused silica glass. FIG. 2 shows the geometric features of the thin film sample structure, denoted as x=[x₁, x₂, x₃]^{T}, which respectively represent the thickness, roughness and non-uniformity of geometric parameters to be measured. The spline model sets equally spaced nodes in the measurement band with an interval of 0.07 eV, and sets additional nodes at positions of 0.66, 0.86, 1.06, 4.63, 5.13, 6.13, and 8.13 eV outside the measurement band for the consideration of out-of-segment absorption.

In the training data constructed in this embodiment, the geometric parameters to be measured are set to film thickness, rough layer thickness and non-uniformity, and the substrate is set to a single layer of fused silica film with a thickness of 0.6 mm. The preset range includes: the parameter range of film thickness is 20 nm to 200 nm, the parameter range of roughness layer thickness is 0 nm to 10 nm, and the parameter range of non-uniformity is −100% to 100%.

The spline model is utilized to fit the dielectric functions of m different thin film materials to obtain multiple sets of spline parameters. According to the random combination of known dielectric functions and geometric parameters, multiple sets of theory optical characterization quantity may be generated through the forward optical property model. The training set is composed of optical characterization quantity and its corresponding spline parameters and geometric parameters.

S2: The neural network is trained with the training set, y_{j,k}^{t} is taken as input, and bⱼ and xₖ corresponding to y_{j,k}^{t} serve as output.

Specifically, the neural network model is constructed, the optical characterization quantity serves as the input of the neural network, the spline parameters and geometric parameters serve as the output, and the deviation between the predicted result of the network and the theoretical value is used as the loss function, and the loss function is used to train a neural network model.

Preferably, the neural network is a fully connected neural network or a convolutional neural network.

Specifically, the neural network model has strong flexibility, so irrelevant output values may be ignored, and it is possible to realize the measurement of various geometric structures (such as whether there is roughness or not).

For example, to construct a residual convolutional neural network, the optical characterization quantity y_{j,k}^{t} in the training set is used as the input of the neural network, the spline parameter bⱼ and the geometric parameter xx are used as the output, and the deviation between the predicted result (bⱼ, xₖ)^{pre} of the network and the theoretical value (bⱼ, xₖ)^{t} is used as a loss function, where the deviation is calculated as the mean square error, and the constructed neural network model is trained by reducing the loss function.

### Application Phase:

S1′: The measured optical characterization quantity y^{mea} of the thin film material to be tested under the measurement conditions in the application phase is obtained and input into the trained neural network to obtain b^{pre} and x^{pre}.

Specifically, according to the neural network trained in S2, the measured optical characterization quantity y^{mea} serves as input, and the preliminary results b^{pre} and x^{pre} of its corresponding geometric parameters and spline parameters may be obtained.

Preferably, in step S1′, the measured optical characterization quantity of the thin film material to be tested under the measurement conditions in the application phase is obtained through an ellipsometer.

Preferably, both the measurement conditions in the application phase and the measurement conditions in the training phase include: an incident angle, a measurement wavelength, a material and a thickness of the substrate.

S2′: b^{pre} and x^{pre} are input into the optical property spline model to obtain y^{t}; the trained neural network is optimized with the goal of minimizing the deviation between y^{mea} and y^{t}.

Specifically, according to the spline model and the forward optical property model, the theoretical optical characterization quantity y^{t} of the preliminary result may be obtained, and the deviation between the theoretical and measured optical property may be calculated. By using this deviation and based on the gradient back propagation algorithm, the neural the network model is optimized.

Preferably, in step S2′, the deviation is mean square error or mean absolute error. The optimization conditions include the maximum number of iterations, the minimum deviation threshold, and so on.

According to the spline parameter b^{pre} given by the neural network model, the dielectric function ε^{pre} of the material is calculated by using the spline model. The dielectric function ε^{pre} calculated by the geometric parameter x^{pre} given by the neural network model and the spline model is calculated, and the theoretical optical characterization quantity y′ may be calculated by using the forward optical property model. The settings of the measurement conditions in the spline model and the forward optical property model may be correspondingly modified according to the specific experimental measurement conditions of the sample, and will not affect the subsequent calculation process, such as changing the incident angle, measurement band, changing the material and thickness of the substrate, reducing the number of spline model nodes, etc. That is to say, the measurement conditions in the application phase and the measurement conditions in the training phase may be the same or different.

In the optimization process of the neural network model, if some output of the neural network is not used, it may be directly omitted in the calculation process, such as not using the roughness thickness, non-uniformity, reducing the number of spline model nodes, etc., and which does not affect the optimization of the neural network model.

S3′: ε^{pre} and x^{pre} are input into the forward optical property model corresponding to the measurement conditions in the application phase to obtain the corresponding theoretical optical characterization quantity y^{t}; the trained neural network is optimized with the goal of minimizing the deviation between y^{mea} and y^{t}. The measurement conditions in the application phase are the same as or different from the measurement conditions in the training phase.

Specifically, when the optimal condition is satisfied, the output value of the neural network with the least deviation is the final geometry and spline parameters of the sample. Further, the spline model and the forward optical property model are utilized, and it is possible to ultimately realize characterization of geometric properties and material optical properties of the thin film material to be tested.

For example, the optimization conditions are set as: the maximum number of iterations is 1000 and the deviation threshold is 10⁻⁶. If the deviation between the theoretical optical characterization quantity y^{t} corresponding to the optimized neural network model output and the measured optical characterization quantity y^{mea} is greater than a threshold, the optimization continues until the condition for termination is met. When the optimization is finished, the neural network with the least deviation is the optimal model. According to the output value of the model, the geometric parameter x and spline parameter b of the sample may be obtained, and then the dielectric function ε of the sample may be obtained by using the spline model, so as to realize the characterization of the sample.

It may be understood that in the application phase, the parameters (such as incident angle, measurement band, distribution of spline node, material and thickness of substrate, etc.) of the measurement condition setting in the forward optical property model may be adjusted according to the new sample to be tested. That is, the measurement conditions in the application phase and the measurement conditions in the training phase may be the same or different.

To sum up, the method provided by the present disclosure first trains the constructed neural network based on the generated data set, so that the neural network has the ability to predict the geometric property parameters corresponding to the given optical characterization quantity. When characterizing a new sample, the spline model and the forward optical property model are utilized to optimize the neural network, and the result obtained by the optimal neural network is the final parameter. Through the present disclosure, the accuracy of the neural network is not affected by the data set, and the physical constraints are satisfied between the real and imaginary parts of the predicted optical properties of the material, which may be generalized for the characterization of different measurement configurations and samples.

The following is an example of nano-thin film measurement based on an ellipsometer, and the optical and geometric properties of three different thin film samples are given.

In this embodiment, the optical characterization quantity is selected as the (N, C. S) spectrum under the incident angle of 65° and the transmittance spectrum under the incident angle of 0°, denoted as y=[y₁, y₂, . . . >y_{n×4}]^{T}, where n is the number of measured wavelengths. In the measurement conditions, the measurement wavelength is set from 1.26 to 4.13 eV, and the wavelength interval is 0.01 eV. FIG. 2 shows the geometric properties of the thin film sample structure, denoted as x=[x₁, x₂, x₃]^{T}, which respectively represent the thickness, roughness and non-uniformity of the geometric parameters to be measured. The spline model sets nodes equally spaced apart in the measurement band, the interval is 0.07 eV, and additional nodes are set at the positions of 0.66, 0.86, 1.06, 4.63, 5.13, 6.13, 8.13 eV outside the measurement band for consideration of the outside of the band absorption.

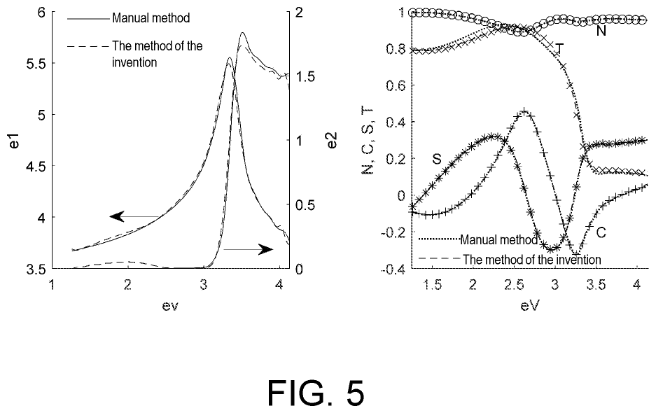

Sample 1 is a non-uniform zinc oxide thin film layer on a fused silica substrate, and the geometric structure thereof is shown in FIG. 2. The actual measured incident angle of the (N,C,S) spectrum of the sample is 65.06°, the incident angle of the transmittance spectrum is 0°, the measurement wavelength is set from 1.26 to 4.13 eV, and the wavelength interval is 0.01 eV. The spline model sets nodes equally spaced apart in the measurement band with an interval of 0.07 eV, and additional nodes are set at the positions of 0.66, 0.86, 1.06, 4.63, 5.13, 6.13, and 8.13 eV outside the measurement band, and the thickness of the fused silica substrate is 0.6 mm. According to manual analysis, the film thickness of the sample is 130.84 nm, the roughness is 3.51 nm, and the non-uniformity is 4.23%. FIG. 5 shows the results of the characterization method provided by the present disclosure, the film thickness of the sample is 130.14 nm, the roughness is 3.6 nm, and the non-uniformity is 4.3%. The dielectric functions obtained by the method provided by the disclosure and the manual analysis method are consistent.

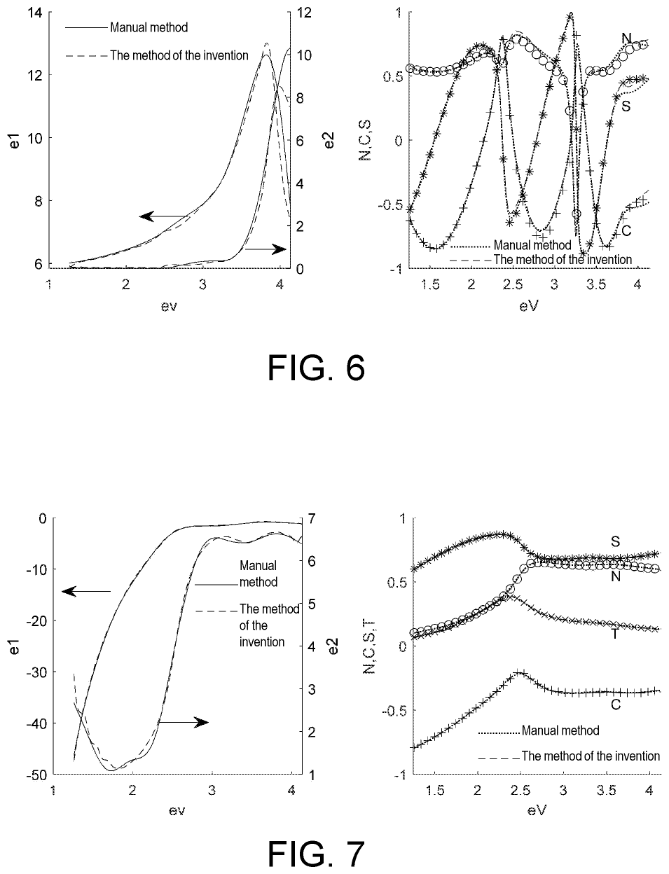

The substrate of sample 2 is silicon and silicon dioxide thin film layer, the thin film layer to be tested is titanium dioxide, and the geometric structure thereof is shown in FIG. 3. The actual measured incident angle of the (N,C,S) spectrum of this sample is 65.06°, the transmittance spectrum is set to zero, the measurement wavelength is set to 1.26 to 4.13 eV, the wavelength interval is 0.01 eV, and the spline model sets nodes equally spaced apart in the measurement band with an interval of 0.07 eV, and sets additional nodes at positions of 0.66, 0.86, 1.06, 4.63, 5.13, 6.13, and 8.13 eV outside the measurement band, and the thickness of silicon dioxide is 201.76 nm. According to manual analysis, the film thickness of the sample is 76.79 nm, and the roughness is 2.54 nm. FIG. 6 shows the results of the characterization method provided by the present disclosure, the film thickness of the sample is 75.05 nm, and the roughness is 4.2 nm. The dielectric functions obtained by the two methods are consistent.

The geometric structure of the gold thin film on the Schott glass substrate of sample 3 is shown in FIG. 4. The actual measured incident angle of the (N,C,S) spectrum of the sample is 65.06°, the incident angle of the transmittance spectrum is 0°, the measurement wavelength is set from 1.26 to 4.13 eV, and the wavelength interval is 0.01 eV. The spline model sets nodes equally spaced apart in the measurement band with an interval of 0.07 eV, and sets additional nodes at positions of 0.66, 0.86, 1.06, 4.63, 5.13, 6.13, 8.13 eV outside the measurement band, and the thickness of the Schott glass substrate is 0.5 mm. According to manual analysis, the film thickness of the sample is 24.05 nm. FIG. 7 shows the results of the characterization method provided by the present disclosure, the film thickness of the sample is 24.06 nm. The dielectric functions obtained by the two methods are consistent.

An embodiment of the present disclosure provides a system for determining optical properties and geometric properties of a thin film material, including: a computer-readable storage medium and a processor.

The computer-readable storage medium is configured to store executable instructions.

The processor is configured to read executable instructions stored in the computer-readable storage medium, and execute the method as described in any one of the above embodiments.

An embodiment of the present disclosure provides a computer-readable storage medium, where the computer-readable storage medium stores computer instructions, and the computer instructions are provided to cause a processor to execute the method described in any one of the above-mentioned embodiments.

It is easy for those skilled in the art to understand that the above descriptions are only preferred embodiments of the present disclosure, and are not intended to limit the present disclosure. Any modifications, equivalent replacements and improvements made within the spirit and principles of the present disclosure should all be included within the protection scope of the present disclosure.

What is claimed is:

1. A method for measuring optical properties and geometric properties of a thin film material, comprising:
a training phase, wherein
S1: a spline parameter bⱼ is determined according to a dielectric function εⱼ(E)=ε_{j,1}(E)+iε_{j,2}(E) and an optical property spline model of m different thin film materials respectively; geometric parameters of a thin film sample are randomly selected within a preset range to obtain a plurality of geometric parameter sets x₁, x₂, . . . , xₙ, each εⱼ and set xₖ are input to a forward optical property model corresponding to measurement conditions in the training phase to obtain a theoretical optical characterization quantity y_{j,k}^{t} to construct a training set; wherein j∈[1, m], k∈[1, n], and
S2: y_{j,k}^{t} is taken as input, and corresponding bⱼ and xₖ serve as outputs, the training set is adopted to train a neural network, and
an application phase, wherein
S1′: a measured optical characterization quantity yₘₑₐ of a thin film material to be tested under measurement conditions in the application phase is obtained and input into the trained neural network to obtain b^{pre} and x^{pre},
S2′: b^{pre} is input into the optical property spline model to obtain ε^{pre},
S3′: ε^{pre} and x^{pre} are input into a forward optical property model corresponding to the measurement conditions in the application phase to obtain a corresponding theoretical optical characterization quantity y^{t}; the trained neural network is optimized with a goal of minimizing a deviation between y^{mea} and y^{t}, wherein the measurement conditions in the application phase are the same as or different from the measurement conditions in the training phase, and
S4′: y^{mea} is input into the optimized neural network to obtain b′^{pre} and x′^{pre}, and b′^{pre} is input into the optical property spline model to obtain ε′^{t}.

2. The method for measuring the optical properties and the geometric properties of the thin film material according to claim 1, wherein in step S1, the optical property spline model is established based on a B-spline model, or
the optical property spline model is established based on the B-spline model and a pole oscillator model.

3. The method for measuring the optical properties and the geometric properties of the thin film material according to claim 2, wherein when a cubic B-spline model is adopted, the optical property spline model based on the B-spline model and the pole oscillator model is established as follows:
$${ε}_{2} ( E ) = {\sum }_{i = 1}^{M - 2} {b}_{i} {B}_{i}^{3} ( E ) ;$$
$${ε}_{1} ( E ) = {b}_{M - 1} - \frac{{b}_{M}}{{E}^{2}} + {\sum }_{i = 1}^{M - 2} {b}_{i} {ϕ}_{i}^{3} ( E )$$
wherein E is a photon energy of a measured wavelength, Bᵢ³(E) and ϕᵢ³(E) are cubic basis functions utilized to calculate an imaginary part and a real part of the dielectric function respectively, b=(b₁, . . . , b_{M}), and M is a number of spline parameters.

4. The method for measuring the optical properties and the geometric properties of the thin film material according to claim 1, wherein the forward optical property model is established based on a thin film transfer matrix method, a rigorous coupled wave analysis, a boundary element method or a finite-difference time-domain method, and corresponding measurement conditions; the measurement conditions are the measurement conditions in the application phase or the measurement conditions in the training phase.

5. The method for measuring the optical properties and the geometric properties of the thin film material according to claim 1, wherein in step S1′, the measured optical characterization quantity of the thin film material to be tested under preset measurement conditions is obtained through an ellipsometer;
in step S2′, the deviation is a mean square error or a mean absolute error.

6. The method for measuring the optical properties and the geometric properties of the thin film material according to claim 1, wherein the optical characterization quantity is at least one of a reflectance, a transmittance, ellipsometric parameters, and a Mueller matrix;
the geometric parameter is at least one of a thickness, a roughness and a non-uniformity.

7. The method for measuring the optical properties and the geometric properties of the thin film material according to claim 1, wherein the preset measurement conditions comprise: an incident angle, a measurement wavelength, a material and a thickness of a substrate.

8. The method for measuring the optical properties and the geometric properties of the thin film material according to claim 1, wherein the neural network is a fully connected neural network or a convolutional neural network.

9. A system for determining optical properties and geometric properties of a thin film material, comprising: a computer-readable storage medium and a processor;
wherein the computer-readable storage medium is configured to store executable instructions;
the processor is configured to read executable instructions stored in the computer-readable storage medium, and execute the method as claimed in claim 1.

10. A computer-readable storage medium, wherein the computer-readable storage medium stores computer instructions, and the computer instructions are provided to cause a processor to execute the method as claimed in claim 1.

11. The method for measuring the optical properties and the geometric properties of the thin film material according to claim 4, wherein the preset measurement conditions comprise:
an incident angle, a measurement wavelength, a material and a thickness of a substrate.

12. A system for determining optical properties and geometric properties of a thin film material, comprising: a computer-readable storage medium and a processor;
wherein the computer-readable storage medium is configured to store executable instructions;
the processor is configured to read executable instructions stored in the computer-readable storage medium, and execute the method as claimed in claim 2.

13. A computer-readable storage medium, wherein the computer-readable storage medium stores computer instructions, and the computer instructions are provided to cause a processor to execute the method as claimed in claim 2.

14. A system for determining optical properties and geometric properties of a thin film material, comprising: a computer-readable storage medium and a processor;
wherein the computer-readable storage medium is configured to store executable instructions;
the processor is configured to read executable instructions stored in the computer-readable storage medium, and execute the method as claimed in claim 3.

15. A computer-readable storage medium, wherein the computer-readable storage medium stores computer instructions, and the computer instructions are provided to cause a processor to execute the method as claimed in claim 3.

16. A system for determining optical properties and geometric properties of a thin film material, comprising: a computer-readable storage medium and a processor;
wherein the computer-readable storage medium is configured to store executable instructions;
the processor is configured to read executable instructions stored in the computer-readable storage medium, and execute the method as claimed in claim 4.

17. A computer-readable storage medium, wherein the computer-readable storage medium stores computer instructions, and the computer instructions are provided to cause a processor to execute the method as claimed in claim 4.

18. A system for determining optical properties and geometric properties of a thin film material, comprising: a computer-readable storage medium and a processor;
wherein the computer-readable storage medium is configured to store executable instructions;
the processor is configured to read executable instructions stored in the computer-readable storage medium, and execute the method as claimed in claim 5.

19. A computer-readable storage medium, wherein the computer-readable storage medium stores computer instructions, and the computer instructions are provided to cause a processor to execute the method as claimed in claim 5.

20. A system for determining optical properties and geometric properties of a thin film material, comprising: a computer-readable storage medium and a processor;
wherein the computer-readable storage medium is configured to store executable instructions;
the processor is configured to read executable instructions stored in the computer-readable storage medium, and execute the method as claimed in claim 6.
